(19) United States
(12) Patent Application Publication
(10) Pub. No.: US 2013/0334396 A1
(43) Pub. Date: Dec. 19, 2013

(54) Anchor used for securing a motor and boat onto the beach

(71) Applicant: Bret Gregory Gifford, (US)

(72) Inventor: Bret Gregory Gifford, (US)

(21) Appl. No.: 13/507,228

(22) Filed: Jun. 13, 2012

(51) Int. Cl. F16M 1/04

(52) U.S. Cl. 248/640

(57) ABSTRACT

An anchor that is of a shape and size to receive and support a portion of the motor (such as the skag) thereon while the motor is affixed onto the boat. More importantly when the motor is positioned and then lowered onto the anchor, a portion of the anchor is forcibly urged downward into the underlying beach (and/or ground surface of user choice) thus resulting in stabilization of the anchor, the motor and boat in combination simultaneously.

### FIELD OF THE INVENTION

The present invention relates in general to a portable free standing structure used for supporting the motor of a boat thereon and functions as an anchor to stabilize both the motor and the boat when situated on the beach and/or any other ground surface. More particularly, the present invention relates to anchor means that is of a shape and size to receive and support a portion of the motor (such as the skag) thereon while the motor is affixed onto the boat. More importantly when the motor is positioned and then lowered onto the anchor, a portion of the anchor is forcibly urged downward into the underlying beach (and/or ground surface of user choice) thus resulting in stabilization of the anchor, the motor and boat in combination simultaneously.

### DESCRIPTION OF PRIOR ART

Numerous innovations for outboard motor supports have been provided in the prior art that will be described. Even though these innovations may be suitable for the specific individual purposes to which they address, they differ from the present invention as will be seen within the specification.

It is to be understood within the known prior art there are many examples of outboard motor supports but none are functional for support of the motor while attached onto the boat. Thus the present invention is novel and unique as nowhere in the prior art did the applicant find a motor and boat anchor as provided herein. However, for examples of the known prior art the following are for reference.

A FIRST EXAMPLE is U.S. Pat. No. Des. 302,619 issued to Catonzaro which teaches the ornamental design for an outboard motor storage rack.

A SECOND EXAMPLE is U.S. Pat. No. 4,044,978 issued to Williams and provides a stand for supporting boat motors comprising a generally horizontally disposed base and a motor support means for supporting the boat motor on the base with connection means for connecting the stand to the cavitation plate of the boat motor on each side of the motor and a support member extending between the base and the connection means.

A THIRD EXAMPLE is U.S. Pat. No. 4,108,425 issued to Crabtree which teaches a repair stand for heavy objects such as outboard motors that has a base with a vertical standard. The standard has a vertically adjustable carrier tube with a horizontal cross rod on its upper end. A mounting plate is secured to the rod on arms with bearings whereby it is pivotal about the rod. A hydraulic cylinder with an extensible and retractable ram is positioned on the carrier tube and is connected, through a channel track and trolley, to the plate to effect controlled pivotal movement thereof.

A FOURTH EXAMPLE is U.S. Pat. No. 4,570,960 issued to Peetz which teaches a cart that has a clamp securing it to the cavitation plate on the stem of the motor. The cart stands upright on two rear wheels and a front leg, allowing it to be tilted and wheeled up or down stairs. An arched frame partially surrounds and protects the propeller.

A FIFTH EXAMPLE is U.S. Pat. No. 5,020,708 issued to Kalbach and teaches an outboard motor stand apparatus for use in a vehicle wherein the apparatus includes a mounting unit secured to the interior of a vehicle, a main support unit rotate ably connected to the mounting unit and an auxiliary support unit pivotally secured to the main support unit. The auxiliary support unit is further provided with a hinged mounting block member adapted to be engaged by the engine mount of an outboard motor.

A SIXTH EXAMPLE is U.S. Pat. No. 5,566,960 issued to McCrory which teaches a storage and carriage stand for an outboard motor. The stand has a wheeled base constructed of opposing elongate side portions and a transversely positioned interior end portion which extends between the side portions tubular steel members. The base members support a frame which includes opposed upright members which are interconnected by a transversely positioned and vertically disposed generally planar shaped transom, to which an outboard motor may be securely affixed. The transport stand base is generally U-shaped so as to include an open end, with the open end being of sufficient width to allow a selected outboard motor which is being attached to said stand to freely pass between said opposing elongate side portions until said transom is reached by the outboard motor.

A SEVENTH EXAMPLE is U.S. Pat. No. 5,680,931 issued to Hashimoto et al. Which teaches an outboard motor packing structure convertible to a display stand, having a rectangular parallelepiped formed with rod members, which rod members include first side rods on both right and left sides connecting the front and back rods, in which an end of each first side rod is detached from the front rods and connected to the bottom rods when the packing structure accommodating an outboard motor therein is converted to a display stand by disjointing parts of the rods, wherein the outboard motor is in the same position as when installed in a boat.

As can be seen the cited references pertaining to the prior art are functional for their intended use but none of the references known to the applicant are intended for use with the motor while on the boat. More importantly none of the references can be utilized for securing the motor and boat onto a ground surface such as the beach or the like.

### SUMMARY OF THE INVENTION

It is therefore an object of the present invention to provide an anchor that is used for securing a motor and boat onto the beach that is portable and easy to use.

Another object of the present invention is to provide an anchor that is used for securing a motor and boat onto the beach wherein the anchor is simple in construction, it requires no tools for assembly and has no moving parts.

Still another object of the present invention is to provide an anchor that is used for securing a motor and boat onto the beach that is inexpensive to manufacture and economically cost effective.

Yet another object of the present invention is to provide an anchor that is used for securing a motor and boat onto the beach that can be made of any material of choice, such as from plastic, aluminum, rubber, wood, or the like.

Another object of the present invention is to provide an anchor that is used for securing a motor and boat onto the beach that is usable with substantially any type of motor of user choice such as an inboard, outboard, inboard/outboard or twin drive, etc.

Also a further object of the present invention is to provide an anchor that is used for securing a motor and boat onto the beach that is can be manufactured to include numerous variations and shapes of engineering choice.

It is to be understood the novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawings.

### BRIEF DESCRIPTION OF THE DRAWING

The figures of the drawings are briefly described as follows:

FIG. 1 is substantially a plan overview of a first embodiment for the present invention.

FIG. 2 is substantially a top view of the embodiment of FIG. 1.

FIG. 3 is substantially a bottom view of the embodiment of FIG. 1.

FIG. 4 is substantially an end view of the embodiment of FIG. 1.

### DETAILED DESCRIPTION OF THE DRAWINGS

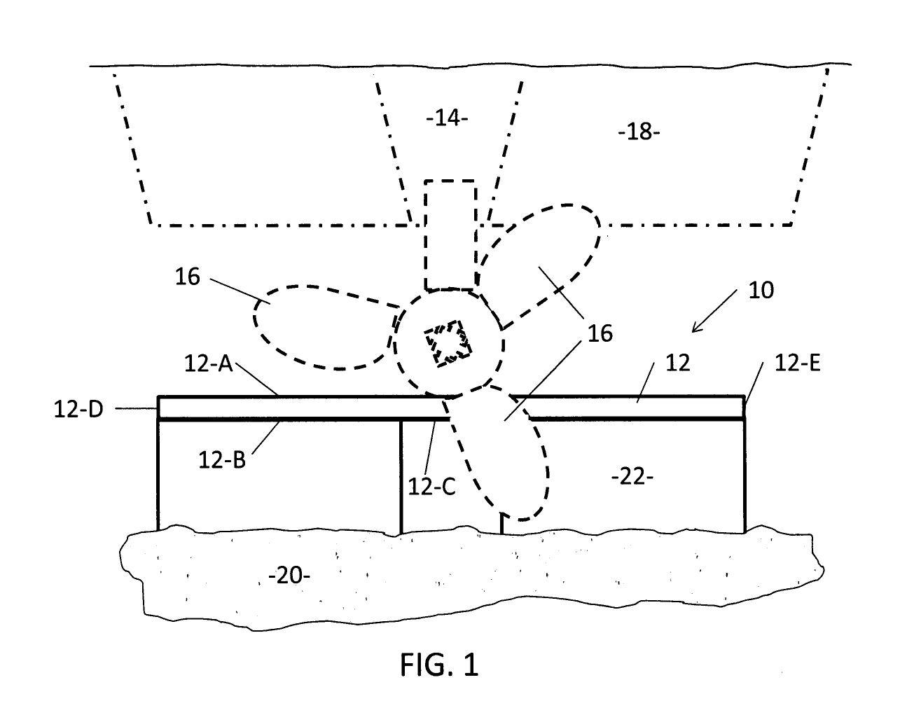

Referring now in detail to the drawings wherein like characters refer to like elements throughout the various views. As depicted in FIG. 1, (10) is a general overview for a first embodiment for the present invention. The anchor (12) of the present invention is used for securing a pre-existing motor (14) having a standard attached propeller (16) and is mounted onto the pre-existing boat (18) and the pre-existing components (14, 16 and 18) are appropriately represented in ghost lines. As illustrated therein each of the components in combination (18, 14, 16 and 12) are positioned and secured in place by the anchor (12) onto the ground surface (20) when not in use, such as when beached or the like.

In general as can be seen, the anchor (12) comprises an elongated platform having a top surface (12-A), a bottom surface (12-B), a central section (12-C), a first end (12-D) and a second end (12-E). Also the bottom surface (12-B) has an elongated downwardly projecting leg (22) extending from the first end (12-D) to the second end (12-E) and the top surface (12-A) located above the central section (12-C) is of an appropriate shape and size to support the standard skag associated with the motor/propeller (14 & 16) thereon in alignment across the width respectively. Whereby, it can be seen that when the skag of the motor/propeller (14 & 16) is positioned and lowered onto the top surface (12-A) above the central section (12-C) the elongated downwardly projecting leg (22) is forcibly urged downward into the underlying ground surface (20) such as the beach, this resulting in the motor/propeller (14 & 16) and the boat (18) being secured in a removably affixed manner until the motor/propeller (14 & 16) and/or skag is raised there from.

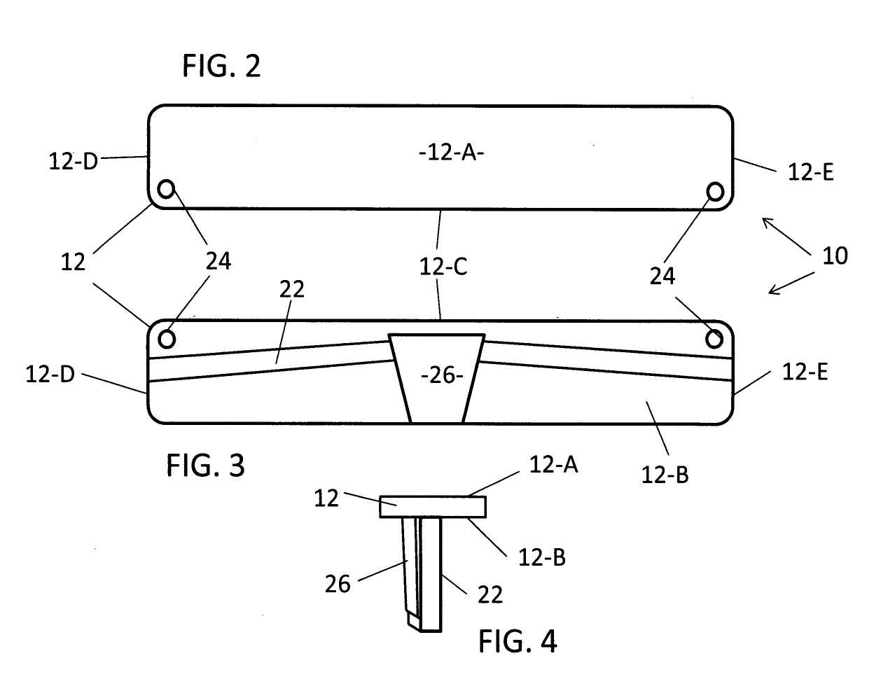

Referring now to FIG. 2, which is substantially a top view of the embodiment of FIG. 1. As illustrated therein the elongated platform of the anchor (12) may further include (as an option) additional attachment means for securing the elongated platform with the motor (14) and boat (18) onto said beach (20). It is to be noted any suitable type of attachment means of engineering choice may be incorporated thus the following attachment means is only exemplary of one suitable means. As depicted, the elongated platform further includes at least one aperture (24) there through which is of a shape and size to receive and retain a spike (not shown) therein.

Referring now to FIG. 3, which is substantially a bottom view of the embodiment of FIG. 1. As illustrated therein the preferred shape of the elongated downwardly projecting leg (22) is non-linear as this tends to further secure the anchor (12) onto the beach (20). Still a further optional feature may include upon the bottom surface (12-B) (located below the central section 12-C) an additional reinforcement support means of engineering choice. For example as depicted in FIGS. 1 & 3 (26) is a reinforcement support means that is substantially in the shape of a wedge or any other shape of engineering choice.

It can now be seen I have herein provided a new and novel anchor used for securing a motor and boat onto the beach of which heretofore has not been anticipated, addressed, recognized and/or implemented within the known prior art.

Although the invention has been herein shown and described in what is conceived to be the most practical and preferred embodiment, it is recognized that departures may be made there from within the scope and spirit of the invention, which is not to be limited to the details disclosed herein but is to be accorded the full scope of the claims so as to embrace any and all equivalent devices and apparatuses.

What I claim as new and wish to secure by Letters Patent is:

1. An anchor used for securing a motor and boat onto the beach comprising in combination: an elongated platform having a top surface; a bottom surface; a central section; a length; a width; a first end; and a second end; said bottom surface having an elongated downwardly projecting leg extending from said first end to said second end and said top surface above said central section being of a shape and size to support the skag of said motor thereon in alignment across said width,
whereby;
when said skag of said motor is positioned and lowered onto said top surface above said central section said elongated downwardly projecting leg is forcibly urged downward into the underlying said beach resulting in said motor and said boat being secured in a fixed manner until said skag is raised there from.

2. The anchor used for securing a motor and boat onto the beach of claim 1 wherein said elongated downwardly projecting leg is further non-linear.

3. The anchor used for securing a motor and boat onto the beach of claim 1 wherein said bottom surface located below said central section further includes an additional reinforcement support means.

4. The anchor used for securing a motor and boat onto the beach of claim 1 wherein said elongated platform further includes at least one aperture there through which is of a shape and size to receive and retain a spike therein if needed to further secure said elongated platform with said motor and said boat onto said beach.

5. The anchor used for securing a motor and boat onto the beach of claim 1 is made by injection moulding.
